(19) United States
(12) Patent Application Publication
(10) Pub. No.: US 2020/0089884 A1
(43) Pub. Date: Mar. 19, 2020

(54) Method and apparatus for ransomware detection

(71) Applicant: AXXANA (ISRAEL) LTD., Tel Aviv (IL)

(72) Inventor: Alex Winokur, Ramat Gan (IL)

(21) Appl. No.: 16/568,301

(22) Filed: Sep. 12, 2019

Related U.S. Application Data
(60) Provisional application No. 62/731,999, filed on Sep. 17, 2018.

(51) Int. Cl. G06F 21/56; G06N 5/02

(52) U.S. Cl. CPC G06F 21/566; G06F 2221/033; G06N 5/025

(57) ABSTRACT

Methods, apparatus and computer software products implement embodiments of the present invention that include storing a set of malware detection rules for a set of respective storage entities, each given rule indicating, when applied to a request to write to a given respective storage entity, whether the request originates from one or more malware applications that corrupt the storage entities. Upon receiving a new request to write data to a given storage entity, a given malware detection rule corresponding to the given storage entity is identified from the set of malware detection rules, and the identified malware detection rule is applied to the received new request so as to detect that the computer is infected with a given malware application. A responsive action can be initiated upon detecting the given malware application infection.

### CROSS-REFERENCE TO RELATED APPLICATIONS

This application claims the benefit of U.S. Provisional Patent Application 62/731,999, filed Sep. 17, 2018, which is incorporated herein by reference.

### FIELD OF THE INVENTION

The present invention relates generally to data storage, and particularly to identifying data storage requests that were generated by a computer infected with malware.

### BACKGROUND OF THE INVENTION

Malware is an abbreviation for malicious software (e.g., executable code, scripts and active content) that when executed, intentionally causes damage to a computer or to data stored on the computer. Examples of malware include computer viruses, worms, Trojan horses, ransomware, spyware, adware, and scareware.

Ransomware (i.e., one of the types of malware cited supra) is a type of malicious software that threatens to perpetually block access to data accessible to a computer unless a ransom is paid. The data can be stored on the computer or on a storage device connected to the computer. Data is typically blocked by encrypting files, thereby making them unusable, and demanding a ransom payment to decrypt them.

Ransomware attacks are typically carried out using a Trojan that is disguised as a legitimate file carrying the malware that a user of the computer is tricked into downloading or opening when received as an email attachment. Some other ransomware attacks can be carried through a “worm” travelling automatically between computers (e.g., servers) without requiring any user interaction to infect the computer(s) with the malware.

Once a computer is infected, the ransomware systematically encrypts some or all of the data portions of storage volumes accessible to the computer, making the data inaccessible to applications executing on the device. In some configurations, ransomware comprises an application that reads data from the storage volumes, encrypts the data and overwrites the volumes with the encrypted data. When a ransom is paid, decryption software is provided by the attacker that enables the computer to decrypt back the data and reinstate it to the state prior to the attack.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method including storing, by a processor in a memory, a set of malware detection rules for a set of respective storage entities, each given rule indicating, when applied to a request to write to a given respective storage entity, whether the request originates from one or more malware applications that corrupt the storage entities, receiving, by the processor, a new request to write data to a given storage entity, identifying, from the set of malware detection rules, a given malware detection rule corresponding to the given storage entity, applying, by the processor, the identified malware detection rule to the received new request so as to detect that the computer is infected with a given malware application, and initiating a responsive action upon detecting the given malware application infection.

In some embodiments, the method also includes storing the data to the storage entity upon detecting, by applying the identified malware detection rule, that the computer is not infected with any given malware application.

In one embodiment, at least one of the malware applications includes a ransomware application. In another embodiment, each given storage entity can be selected from a list consisting of a storage device, a logical volume, a file, a volume block and a file block.

In additional embodiments, the processor includes a first processor, wherein receiving the new request includes receiving, by the first processor, a new request from a software application executing on a second processor, and wherein a given malware detection rule is based on known behavior of how the software application stores data to the given software entity.

In further embodiments, the given malware detection rule includes an address of a first buffer, wherein the request includes an address of a second buffer, and wherein applying the given malware detection rule includes comparing the address of the first buffer to the address of the second buffer.

In supplemental embodiments, the given malware detection rule includes a timeframe, and wherein applying the given malware detection rule includes determining a time when the processor received the request, and comparing the determined time to the timeframe.

In some embodiments, the given malware detection rule includes a specified format, and wherein applying the given malware detection rule includes comparing the received data to the specified format.

In additional embodiments, the given malware detection rule includes a first location in an ordered set of the storage entities, wherein the request includes a second location in the given storage entity, and wherein applying the given malware detection rule includes comparing first location in the ordered set of the storage entities to the second location in the given storage entity.

In further embodiments, the given malware detection rule includes a first signature, and wherein applying the given malware detection rule includes computing a second signature based on the new request, and comparing the first signature to the second signature.

In one embodiment, the responsive action includes generating an alert. In another embodiment, the responsive action includes halting write operations to the storage entities.

There is also provided, in accordance with an embodiment of the present invention, an apparatus, including a memory, and a processor configure to store, in the memory, a set of malware detection rules for a set of respective storage entities, each given rule indicating, when applied to a request to write to a given respective storage entity, whether the request originates from one or more malware applications that corrupts the storage entities, to receive a new request to write data to a given storage entity, to identify, from the set of malware detection rules, a given malware detection rule corresponding to the given storage entity, to apply the identified malware detection rule to the received new request so as to detect that the computer is infected with a given malware application, and to initiate a responsive action upon detecting the given malware application infection.

There is further provided, in accordance with an embodiment of the present invention, a computer software product, the product including a non-transitory computer-readable medium, in which program instructions are stored, which instructions, when read by a computer, cause the computer to store, in a memory, a set of malware detection rules for a set of respective storage entities, each given rule indicating, when applied to a request to write to a given respective storage entity, whether the request originates from one or more malware applications that corrupts the storage entities, to receive a new request to write data to a given storage entity, to identify, from the set of malware detection rules, a given malware detection rule corresponding to the given storage entity, to apply the identified malware detection rule to the received new request so as to detect that the computer is infected with a given malware application, and to initiate a responsive action upon detecting the given malware application infection.

### BRIEF DESCRIPTION OF THE DRAWINGS

The disclosure is herein described, by way of example only, with reference to the accompanying drawings, wherein:

FIG. 1 is a block diagram that schematically shows a computing facility comprising a storage controller and a plurality of computers comprising respective operating system layers, in accordance with a first configuration embodiment of the present invention;

FIG. 2 is a block diagram that schematically shows components of a given operating system layer comprising a malware protection system, in accordance with the first configuration embodiment of the present invention;

FIG. 3 is a block diagram that schematically shows an alternative configuration of the storage controller, in accordance with a second configuration embodiment of the present invention;

FIG. 4 is a block diagram that schematically shows an alternative configuration of the operating system layer, in accordance with the second configuration embodiment of the present invention;

FIG. 5 is a block diagram that schematically shows data components of the malware protection system, in accordance with an embodiment of the present invention;

FIG. 6 is a block diagram that schematically shows software modules of the malware protection system, in accordance with an embodiment of the present invention;

FIG. 7 is a flow diagram that schematically illustrates a method of using the malware protection system to detect a malware infection in a given computer, in accordance with an embodiment of the present invention; and

FIG. 8 is a block diagram that schematically illustrates a dataflow for detecting a malware infection in a given computer, in accordance with a first collaboration embodiment of the present invention; and

FIG. 9 is a block diagram that schematically illustrates a dataflow for detecting a malware infection in a given computer, in accordance with a second collaboration embodiment of the present invention.

### DETAILED DESCRIPTION OF EMBODIMENTS

### Overview

Methods that attempt to prevent ransomware from infecting a computer are known in the art. However, once an infection does occur, it is very difficult to recover all infected data without paying the ransom. For example, if a computer is infected by ransomware, the infection is typically detected when an application tries accessing a volume which was already encrypted, causing the application (or the entire computer) to fail. By the time the infection is detected, large portions of the volume's data are likely to be already encrypted, thereby making recovery without paying a ransom almost impossible.

Embodiments of the present invention provide methods and systems for detecting a data storage operation comprising data that was corrupted by a malware (e.g., ransomware) infection. As described hereinbelow, a set of malware detection rules for a set of respective storage entities are stored by a processor in a memory, each given rule indicating, when applied to a request to write to a given respective storage entity, whether the request originates from one or more malware applications that corrupt the storage entities (i.e., data stored on the storage entities).

Upon the processor receiving a new request to write data to a given storage entity, a given malware detection rule corresponding to the given storage entity is identified from the set of malware detection rules. The identified malware detection rule can then be applied to the received new request so as to detect that the computer is infected with a given malware application, and a responsive action can be initiated upon detecting the given malware application infection.

Traditional strategies for recovering from ransomware attacks without paying ransom include restoring the data from off-site backups or snapshots. However, these strategies will not be able to recover any data conveyed to the storage system subsequent to the last backup/snapshot before the ransomware attack. Since the malware detection rules can detect data altered by malware prior to any infected data being stored on/by a given computer, systems implementing embodiments of the present invention can achieve zero data loss in the event of malware infecting any given computer in a computing facility.

### System Description

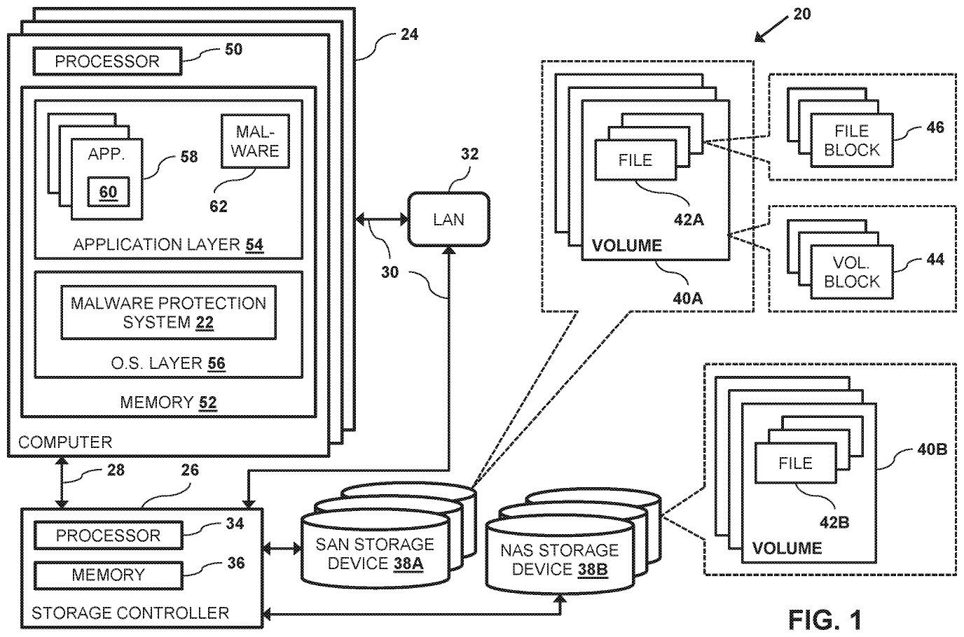

FIG. 1 is a block diagram that schematically shows a computing facility 20 comprising a malware protection system 22 that is configured to detect a malware attack on a computer executing the malware protection system, in accordance with a first configuration embodiment of the present invention.

In the configuration shown in FIG. 1, computing facility comprises computers 24 that convey block-level storage commands and file-level storage commands to a storage controller 26. When receiving processing block-level storage commands, storage controller 26 communicates with computers 24 via a storage area network connection such as a Fibre Channel connection 28 that typically comprises a pair of host bus adapters (not shown). When receiving and processing file-level storage commands, storage controller 26 communicates with computers 24 via a network attached storage (NAS) connection 30 that comprises a pair of network interface cards (not shown) that communicate over a local area network (LAN) 32.

Storage controller 26 comprises a storage processor 34 and a storage memory 36, and is coupled to one or more storage devices 38 that can be partitioned into logical volumes 40 (also referred herein simply as volumes 40) that can store files 42. Volumes 40 comprise volume blocks 44, and files 42 comprise file blocks 46 that can be mapped to the volume blocks using file system metadata incorporated within volumes 40. The mapping can be done either by processor 50 for SAN storage devices 38A, or by processor 34 for NAS storage devices 38B.

In FIG. 1, storage devices 38, volumes 40 and files 42 are differentiated by appending a letter to the identifying numeral, so that the storage devices comprise SAN storage devices 38A, NAS storage devices 38B, the volumes comprise volumes 40A and 40B, and the files comprise files 42A and 42B.

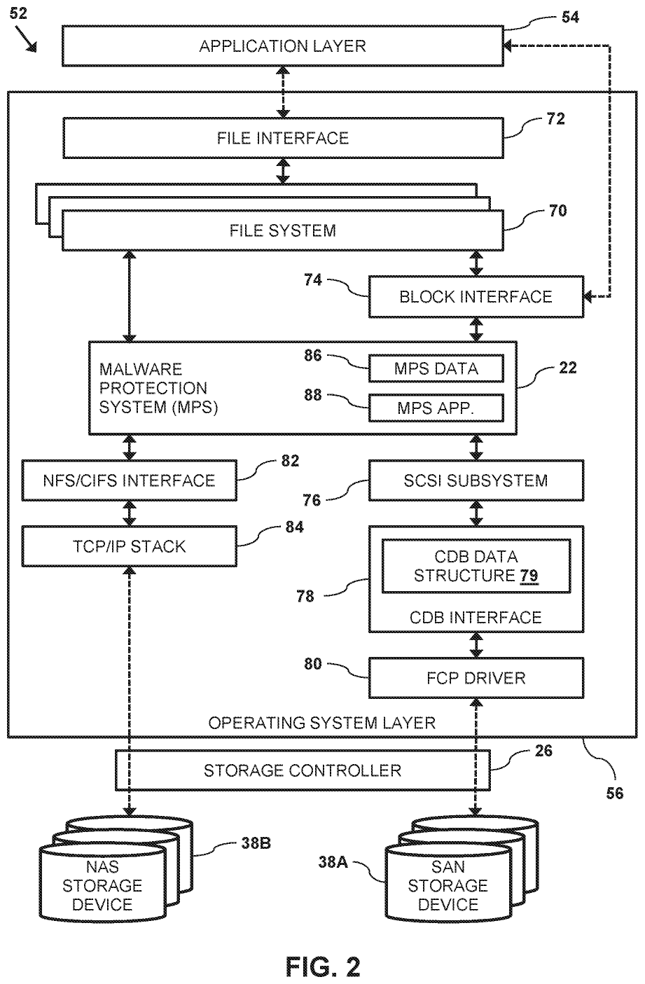

Each computer 24 may comprise an application processor 50 and an application memory 52 that stores an application layer 54 and an operating system layer 56 (including all the operating system level storage I/O related software components). In operation, processor 50 executes, from application layer 54, one or more legitimate software applications 58 (also referred to herein as applications 58). In some embodiments, a given application 58 may comprises a database management system (DBMS) that processes queries for a database stored in files 42. In operation, applications 58 convey storage requests (e.g., data write requests and data read requests) to operating system layer 56. Operating system layer 56 receives and processes the storage requests from computers 24 to retrieve data from and to store data to files 42 on storage devices 38. Operating system layer 56 implementing the first configuration embodiment of the present invention is described in the description referencing FIG. 2 hereinbelow.

Each application 58 comprises a buffer 60 that comprises a set of specific addresses in memory 52. Upon a given application 58 conveying, to operating system layer 56, a request to store data to a given file 42, the given application may load the data to buffer 60, and in response to receiving the request, the operating system layer retrieves the data from the buffer and stores the data to the given file. Likewise, upon a given application 58 conveying, to operating system layer 56, a request to retrieve data from a given file 42, the operating system layer, in response to receiving the request, retrieves the data from the given file and stores the data to buffer 60 which can then be accessed by the given application.

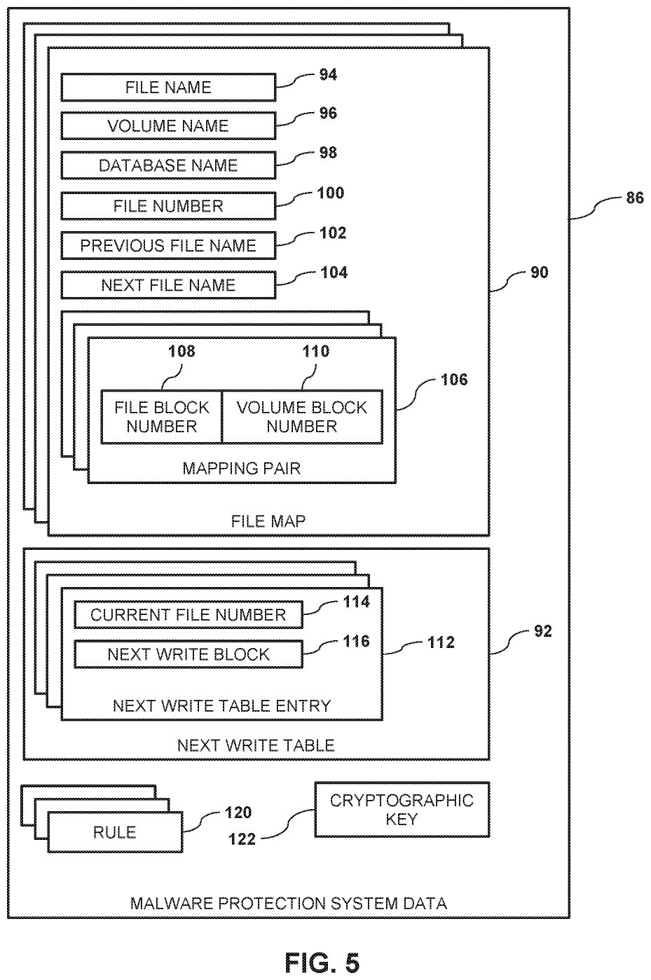

In the configuration shown in FIG. 1, a given computer 24 is infected by a malware application 62 that processor 50 executes from application layer 54. In operation, malware 62 alters data stored in files 42 so that the data is unusable. In some embodiments, malware 62 comprises an application such as the fEstasAzulCorrupta virus that corrupts data in storage entities such as files 42 stored on storage devices 38. In other embodiments, malware 62 comprises ransomware such as Cryptolocker that encrypts data in storage entities such as files 42 stored on storage devices 38. Additional examples of the storage entities are described in the description referencing FIG. 5 hereinbelow.

Processors 34 and 50 comprise general-purpose central processing units (CPU) or special-purpose embedded processors, which are programmed in software or firmware to carry out the functions described herein. This software may be downloaded to storage controller 26 and computers 24 in electronic form, over LAN 32, for example. Additionally or alternatively, the software may be stored on tangible, non-transitory computer-readable media, such as optical, magnetic, or electronic memory media. Further additionally or alternatively, at least some of the functions of these processors may be carried out by hard-wired or programmable digital logic circuits.

Examples of memories 36 and 52 include dynamic random-access memories and non-volatile random-access memories. In some embodiments, memories 36, 52 and storage devices 38 may include non-volatile storage devices such as hard disk drives and solid-state disk drives.

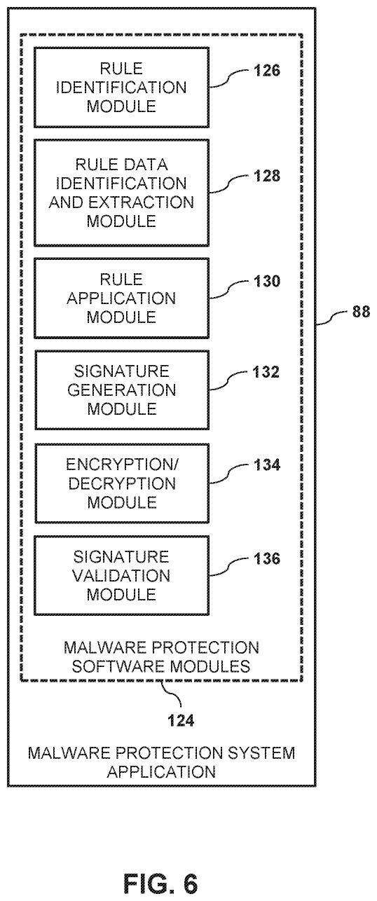

FIG. 2 is a block diagram that schematically shows software components of operating system layer 56 comprising malware protection system 22, in accordance with the first configuration embodiment of the present invention. Malware protection system 22 comprises malware protection system data 86 and a malware protection system application 88. Malware protection system data 86, an example of which is described in the description referencing FIG. 5 hereinbelow, and malware protection system application 88 is described in the description referencing FIG. 6 hereinbelow. In the first configuration embodiment of the present invention, processor 50 executes malware protection system application 88 from operating system layer 56.

In the configuration shown in FIG. 2, operating system layer 56 is configured to process block-level storage operations for SAN storage devices 38A and file-level storage operations for NAS storage devices 38B. In embodiments of the present invention, upon operating system layer 56 receiving and processing a data write request in a given computer 24, malware protection system 22 is configured to determine, by analyzing the data write request, that the given computer is infected with malware 62.

In addition to malware protection system 22, operating system layer 56 also comprises one or more file systems 70, and a file system interface 72. File systems 70 are configured to map files 42 and directories (not shown) to logical volumes 40 on storage devices 38. In some embodiments, file system interface 72 provides information about files 42 that enables software applications (e.g., a DMBS) in application layer 54 to read data from or to write data to the files. The following is an example of an application programming interface (API) call that a given application 58 can use to write data to a given file 42 via file system interface 72 and a given file system 70:
file_write (file_name, offset, #_of_bytes, buffer)

In this example:
file_name comprises a name of the given file to which the write operation is executed. In some embodiments, file_name may comprise a file handle.
Offset is an offset value (i.e., a number of bytes) within the given file where the write operation starts writing the data.
#_of_bytes is a number of bytes to be written (i.e., starting at Offset).
Buffer references a given buffer 60 that stores the data to be written by the write operation. In some embodiments, the Buffer parameter may comprise an address in memory 52 where the given buffer is stored.

To process block-level storage operations for SAN storage devices 38A, operating system layer 56 further comprises a block interface 74, a Small Computer System Interface (SCSI) subsystem 76, a Command Descriptor Block (CDB) interface 78 and a Fibre Channel Protocol (FCP) driver 80. Block interface 74 comprises an interface through which a given file system 70 communicates with the SCSI subsystem using a block level API (not shown). In one embodiment, block interface 74 is used by the given file system. In another embodiment, block interface 74 is directly used by application layer 54. In other words, block interface 74 can be directly accessed by application layer 54 or the given file system.

CDB interface 78 comprises a CDB data structure 79 that that comprises parameters for storage commands (e.g., Read, Write, Read Capacity, Test Unit Ready, Inquiry) supported by storage devices 38. In operation, the parameters are passed to the CDB data structure 79 via CDB interface 78.

The following is an example of an API call that file interface 72 or a given application 58 or can use to write data to a given logical volume 40:
block_write (LUN, block_#, #_of_blocks, buffer)
   where:
LUN is a logical unit number which is synonymous to the given logical volume which is the target of the write operation.
block_# is a first volume block 44 within the given logical volume where the write operation starts storing data.
#_of_blocks is a number of volume blocks 44 to be written to the given logical volume.
Buffer references a given buffer 60 that stores the data to be written by the write operation that staring at block block_# in the logical volume LUN.

In the configuration shown in FIG. 2, malware protection application 88 receives the block_write API call from block interface 74, and analyzes the call in order to determine whether or not the API call indicates the presence of malware 62. If malware protection system application 88 determines that the API call does not indicate the presence of malware 62 then the malware protection system application forwards the API call to SCSI subsystem 76.

SCSI subsystem 76 receives the block_write API call from malware protection system application 88, and translates the received API call to CDB data structure 79, and communicates the CDB data structure to FCP driver 80 using CDB interface 78. FCP driver 80 instructs storage controller 26 to store the data on a given SAN storage device 38A by transferring the CDB data structure over Fibre Channel connection 28 to storage controller 26.

While the example in FIG. 2 shows malware protection system 22 as a software module in operating system layer 56 that is configured to communicate with block interface 74 and SCSI subsystem 76, other configurations of the malware protection system in the operating system layer are considered to be within the spirit and scope of the present invention. For example, malware protection system 22 may be a component of SCSI subsystem 76 or FCP driver 80.

To process file-level storage operations for NAS storage devices 38B, operating system layer 56 additionally comprises a Network File System (NFS)/Common Internet File System (CIFS) interface 82 and a Transmission Control Protocol/Internet Protocol (TCP/IP) communication stack 84. In operation, a given file system 70 translates the file_write( ) API call into an NFS specific command embedded within a TCP/IP frame that the given file system conveys, via NFS/CIFS interface 82, to TCP/IP stack 84. Upon receiving the TCP/IP frame, TCP/IP stack 84 conveys the TCP/IP frame to storage controller 26 which performs the requested write operation on a given NAS storage device 38B. NFS/CIFS interface 82 corresponds to CDB interface 78 for storage, converting the given file system's API into a data structure and sending the data structure through TCP/IP stack 84 over LAN 32.

In the configuration shown in FIG. 2, malware protection system application 88 receives the write API call from a given file system 70, and analyzes the call in order to determine whether or not the API call indicates the presence of malware 62. If malware protection system application 88 determines that the API call does not indicate the presence of malware then the malware protection system application forwards the API call to NFS/CIFS interface 82.

While the example in FIG. 2 shows malware protection system as a software module in operating system layer 56 that is configured to communicate with a given file system 70 and NFS/CIFS interface 82, other configurations of the malware protection system in the operating system layer are considered to be within the spirit and scope of the present invention. For example, malware protection system 22 may be a component of NFS/CIFS interface 82 or TCP/IP stack 84.

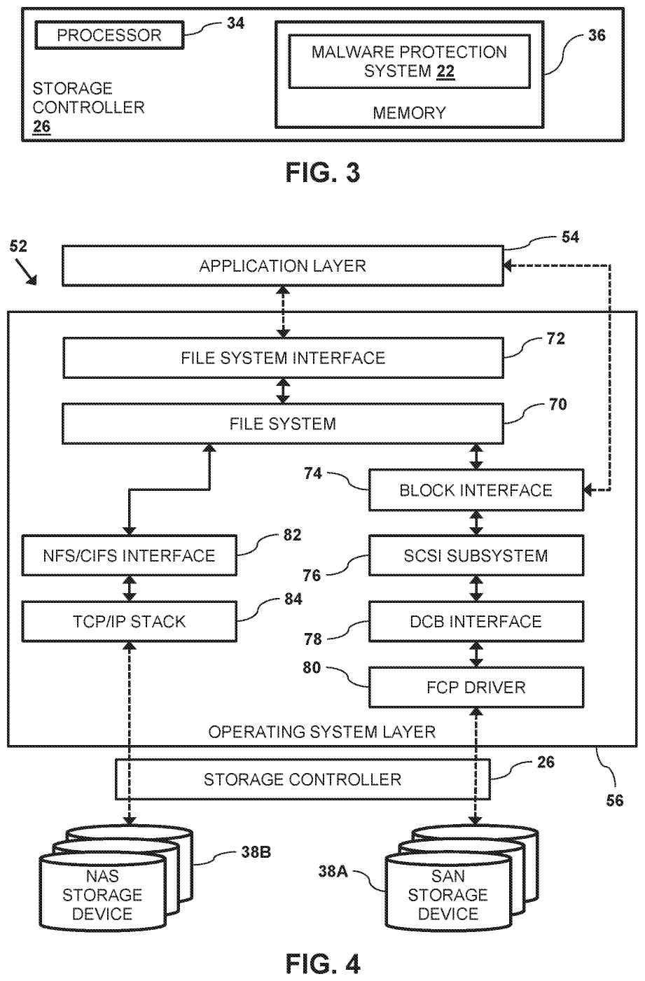

FIG. 3 is a block diagram that schematically shows an alternative configuration of malware protection system 22, and FIG. 4 is a block diagram that schematically shows an alternative configuration of the software components in operating system layer 56, in accordance with a second configuration embodiment of the present invention. In the second configuration embodiment, processor 34 executes malware protection system application 88 from memory 36, as shown in FIG. 3. Therefore, in the second configuration embodiment, upon receiving data write requests received from FCP driver 80 and/or TCP/IP stack 84, storage controller 26 executes malware protection system application 88 to determine any data write requests that indicate the presence of malware 62.

As shown in FIG. 4, block interface 74 communicates directly with SCSI subsystem 76, and a given file system 70 communicates directly with NFS/CIFS interface 82 in the second configuration embodiment.

FIG. 5 is a block diagram that schematically shows an example of malware protection system data 86, in accordance with an embodiment of the present invention. The malware protection system data 86 comprises multiple file maps 90 and a next write table 92.

Each given file map 90 corresponds to a given file 42, and may comprise a file name 94, a volume name 96, a database name 98, a file number 100, a previous file name 102, a next file name 104 and a set of mapping pairs 106. File name 94 comprises a name for the given file, and volume name comprises a name of a given volume 40 that stores the given file. In embodiments where the given file comprises a database file, database name 98 comprises a name of a given database that comprises the given file.

In embodiments where application layer 54 maintains files 42 in a specific order, file numbers 100 comprise numeric value that the application layer can use to maintain the files in an ordered list. In these embodiments, for each given file 42, previous file name 102 comprises a file name of the previous file in the ordered list, and next file name 104 comprises a file name for the subsequent file in the ordered list.

In embodiments where a given application 58 comprises a DBMS, the DBMS can use file numbers 100, previous file name 102 and next file name 104 to maintain, in an ordered list, a set of files 42 that comprise redo log files. In these embodiments, once a given redo log file becomes full (i.e., stores a specific amount of data) or some other application specific criteria is met, the given application can redirect subsequent write operations to the next redo log file in the ordered list. When the last redo log file becomes full or some other application specific criteria is met, the DBMS can direct subsequent writes to the first redo log file in the ordered list (i.e., thereby overwriting the first redo log file).

Each mapping pair 106 comprises a file block number 108 that references a unique file block 46 and a volume block number 110 that references a unique volume block 44. The following is an example of a set of mapping pairs 106:

| FILE BLOCK | VOLUME BLOCK |
|---|---|
| NUMBER 108 | NUMBER 110 |
| 1 | 10 |
| 2 | 5 |
| 3 | 6 |
| 4 | 12 |
| 5 | 3 |
| 6 | 8 |

In operation, processor 50 can query file system 70 for the mapping pairs 106 in file map 90. In an alternative configuration, processor 50 may extract the mapping pairs 106 by querying the X$KFFXP allocation table (not shown), which is an Extent™ mapping table for the Automatic Storage Management™ (ASM) file system which is produced by Oracle Corporation (Redwood City, Calif.).

In embodiments where processor 50 initially creates redo log file 42 by instructing a given file system 70 to create a given mapping pair 106, the application processor can convey the given mapping pair to malware protection system application 88 which in turn can write the mapping pair to a given storage device 38A using the given file system 70 comprising simple file system. In these embodiments the given file system may comprise a simple file system that can be used to manage mapping pairs 106, as described in Appendix 2 hereinbelow.

To convey the given mapping pair to the malware protection system application 88, processor 50 can use the following call level interface (CLI) function that defines a given file map 90:
Map (file_map)
   where file_map map comprise the following data structure:

file_map
{

| | |
|---|---|
| file_name | /* file name 94 |
| file_number | /* file number 100 |
| volume_name | /* volume name 96 |
| database_name | /* database name 98 |
| num_map_entries | /*Number of mapping pairs 106 |

map_entries[num_map_entries]

/* mapping pairs 106

{

| | |
|---|---|
| file_block | /* a given file block 46 |
| volume_block | /* a given volume block 44 |

}

}

where database_name is used to associate the given redo log file to a given database.

Next write table 92 comprises a set of next write table entries 112, each of the next write table entries corresponding to a respective database name 98. Each next write table entry 112 comprises a current file number 114 and a next write block 116. For each next write table entry 112, current file number 114 comprises a given file number 100 corresponding to a given file 42, and next write block 116 comprises a given file block 46 in the given file where the next write operation should store data in the given file.

Malware protection system data 86 also comprises a set of rules 120 and a cryptographic key 122. As described hereinbelow, upon malware protection system application 88 receiving a write request, the malware protection system application applies a given rule 120 to the write request in order to determine whether or not the received write request indicates the presence of malware 62.

In embodiments of the present invention, malware protection system 22 is configured to collaborate with application layer 54 and/or operating system layer 56 in order to detect malware infections. In a first collaboration embodiment, malware protection system 22 collaborates (only) with operating system layer 56, and in a second collaboration embodiment, malware protection system 22 collaborates with application layer 54 and with operating system layer 56. As described hereinbelow, each of the collaboration embodiments comprises respective sets of rules 120.

In the first collaboration embodiment, the rules are based on known behavior of how a given software application 58 (e.g., a DBMS) stores data to files 42. The first collaboration embodiment does not require any changes to be made to any software application 58 that stores data to files 42.

As described supra in the description for the block_write( ) and file_write( ) API calls, each data write request that operating system layer 56 receives from a given application 58 comprises data (i.e., a memory address of a given buffer 60 that stores the data) and a target storage entity for the data. Examples of the storage entities include, but are not limited to, storage devices 38, volumes 40, files 42, volume blocks 44 and file blocks 46.

In embodiments of the present invention, rules 120 can be defined based on knowing how applications 58 store data to the storage entities. Examples of known behavior of applications 58 that can be used by the first collaboration embodiment for defining rules 120 for malware protection system 22 include:
A given file 42 may be associated with a given application comprising a given buffer 60 at a specific address in memory 52. In one example, a given file 42 may comprise a spreadsheet file and a given application 58 may comprise a spreadsheet application. In this example, malware protection system application 88 can use a given rule that checks if the write request for the spreadsheet file references the buffer for the spreadsheet application. If the write request references a different buffer 60, then malware protection system application 88 can determine that the write request indicates malware 62 in a given computer 24.
A given file 42 may be updated at specific dates and/or at specific times of day. In this example, a given rule 120 may indicate that a given write request as suspicious if it is received outside the expected timeframe (i.e., the specific dates and/or times). In this example, malware protection system application 88 can use a given rule that checks if the write request for a given storage entity was received within a specified timeframe. If the write request was received outside the specified timeframe, then malware protection system application 88 can determine that the write request indicates malware 62 in a given computer 24.
A given file 42 may store data in a specific format. For example, if the a given file comprises an Oracle™ database redo file, the data for each volume block 44 in write requests received for the given file includes a header with a well-defined structure and content. If the data in the write request does not include the required header information, malware protection system application 88 can determine that the write request indicates malware 62 in a given computer 24.
A given file 42 may (i.e., be expected to) store data to a specific location in an ordered set of storage entities. In other words, the given file may be configured to store data in a specific order. For example, if a set of files 42 comprises an ordered set of Oracle™ redo log files, (a) each of the redo log files is expected to be written to sequentially (i.e., in file block order), and (b) upon a given redo log file reaching some end of file condition, subsequent writes to the given redo log file are redirected to the next redo log file in the ordered set of redo log files. If the write request does store data in the expected location (i.e., the expected redo log file and/or the expected file block in the redo log file), malware protection system application 88 can determine that the write request indicates malware 62 in a given computer 24.

While the examples of rules 120 for the first collaboration embodiment described above are for files 42, rules 120 for any other type of storage entity are considered to be within the spirit and scope of the present invention.

In the second collaboration embodiment, both malware protection system 22 and applications 58 actively participate in the protection process by “sharing a common secret”. In other words, the second collaboration embodiment requires changes to be made to any software application 58 that stores data to files 42.

In the second collaboration embodiment, a given rule 120 may comprise requiring verification of a signature that is included in each of the write requests for a given file 42. In a first example, the signature may comprise a hash value calculation for the data in the write request. In this example, a given application 42 generates a first signature, and includes the first signature in the write request. Upon receiving the write request, malware protection system application 88 computes a second signature for the write request, and if the first and the second signature do not match, the malware protection system application can determine that the write request indicates malware 62 in a given computer 24 that generated the write request.

In a second example, the first and the second signatures can be computed based on other information in the data write request such as the volume name which is targeted to store the data in the request, and a sequence number for the data write request. In these two examples the common secret comprises a computation method for the signature(s).

Cryptographic kay 122 may be used to encrypt and/or decrypt write request data such as signatures. In one cryptographic embodiment, cryptographic key 122 may comprise a public key, and the given application encrypts the first signature using its own copy of the public key (not shown). Upon receiving the write request and generating the second signature, malware protection system application 88 can encrypt the second signature using public key 122, and compare the encrypted first signature to the second signature.

In another cryptographic embodiment, cryptographic key 122 may comprise a private key, and the given application encrypts the first signature using a corresponding public key (not shown). Upon receiving the write request and generating the second signature, malware protection system application 88 can decrypt the encrypted first signature using private key 122, and compare the first signature to the second signature.

FIG. 6 is a block diagram that shows malware protection system application 88 comprising a set of malware protection software modules 124, in accordance with an embodiment of the present invention. Malware protection software modules 124 comprises a rule identification module 126 (also referred to herein as identification module 126), a rule data identification and extraction module 128 (also referred to herein as data extraction module 128), a rule application module 130, a signature generation module 132, and an encryption/decryption module 134, and a signature validation module 136.

Using embodiments described supra, identification module 126 analyzes each given data write request and identifies one or more rules 120 that malware protection system application 88 can use to validate the given data write request. Upon identifying a given rule 120, data extraction module 128 identifies and extracts the necessary information to process the given malware detection rule. For example, the identified data may comprise information in the data write request such as a number of a given volume block 44 or information such as next write block 116. Upon identifying the given malware detection rule and extracting the necessary information for the identified malware detection rule, rule application module 130 applies the identified malware detection rule to the extracted information.

Signature generation module 132 generates a signature based on the information extracted for the identified malware detection rule. For example, signature generation module 132 can generate a given signature by computing a hash value for the data to be stored by the given data write request, or by computing a hash value for the volume that is the target of the data in the data write request.

In operation, encryption/decryption module 134 can encrypt or decrypt the signatures included in the given data write request or the signatures computed by signature generation module 132, and signature validation module 136 can compare the signature included in the given data write request to the signature computed by signature generation module 132. If the signature included in the given data write request is encrypted, encryption/decryption module 134 can either (a) decrypt the signature included in the given data write request, and signature validation module 136 can validate the received signature by comparing the decrypted signature to the signature generated by signature generation module 132, and determining that the decrypted signature matches the generated signature, or (b) encrypt the signature generated by signature generation module 132, and signature validation module 136 can validate the received signature by comparing the encrypted signature included in the given data write request to the signature that was generated by signature generation module 132 and encrypted by signature generation module 132, and determining that the included signature matches the encrypted signature.

In some embodiments, malware protection system 22 may include an API call that implements the following pseudo-code:

block_protect (Volume_name, block_#, #_of _blocks, buffer)
{

If block_# appears in redo files map tables T on Volume_name
Then
{

database=T.database_name
/*Check header validity
Err = Check_Header(buffer)
If Err ≠ 0 Then

Return(Err)

}
Else /*Block does not belong to redo files

Return(0)

/*Check whether write is to the right location in current
file.
If block_# = database.Next_write _block
& T.file_number = database.Current_file_number Then

Err = 0

Else /*Check whether write to beginning of next file

If block_# = 0 &
T.previous_file_number = database.Current_file_number
Then
{

database.Current_file_number = T.file_number
Err = 0

}
Else

Err = 2

If Err = 0 Then
{

/*calculate location for next write
database.Next_write _block = database.Next_write _block +
#_of _blocks
/*if next write outside file's boundary then next write to
block 0 of next file
If database.Next_write _block > LAST_BLOCK_ON_FILE
Then
{

database.Next_write _block = 0
database.Current_file_name = T.Next_file_name

}
Return(0)

}
Else

Return(Err)

}

### Ransomware Detection

As described supra, ransomware software such as malware 62 typically resides in application layer 54. For example, malware 62 comprises an application that maliciously installs itself on a given computer 24. In one example, malware 62 may implement the following pseudo-code to encrypt files 42A on SAN storage devices 38A:

For all volumes accessible by the server Do

{
For Block = 1 Till Block = last_block_on_volume Do

{
block_read(volume, Block, 1, buffer)
Encrypt buffer
block_write(volume, Block, 1, buffer)
}

}

where volumes are the LUNs accessible from the given computer.

When the ransomware software completes its operation, the data in all files 42A is encrypted. Additionally, there may be instances where files 42A themselves become “invisible”, as the file system metadata which includes directory names, file names, and location of the file blocks on the volumes may be encrypted as well.

Similarly, the ransomware application can operate on a file level. In this case it systematically reads and encrypts each file 42B using the file interface. In this case all file system directories and file names will be visible, and the file system can be traversed by the user, however the content of files 42B themselves are useless as they are encrypted.

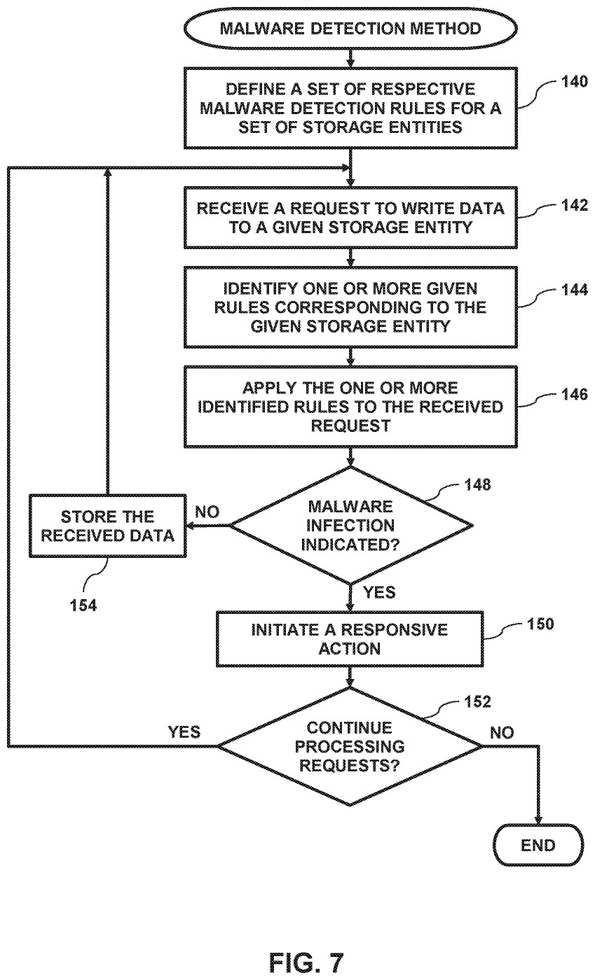

FIG. 7 is a flow diagram that schematically illustrates a method for detecting malware 62 in the application layer of a given computer 24, in accordance with an embodiment of the present invention. Using embodiments described in the description referencing FIG. 6 hereinabove, a set of rules 120 is defined for the storage entities in a definition step 140, and the malware detection rules are stored to malware protection system data 86 in memory 52. In embodiments of the present invention, malware protection system 22 can protect data entities such as files 42 using the first or the second collaboration embodiments described supra.

In a receive step 142, operating system layer 56 receives, from a given computer 24, a request to write data to a given storage entity.

Using embodiments described supra, operating system layer 56 conveys the request to malware protection system application 88, and rule identification module 126 in the malware protection system application identifies one or more given rules 120 that correspond to the received request in an identification step 144.

In an application step 146, rule application module 130 in malware protection system application 88 applies the one or more identified rules to the received data write request.

In a first comparison step 148, if rule application module 130 determines that the one or more applied rules indicate that malware 62 is executing on the given computer so as to alter or encrypt the data in the data write request, then in an action step 150, malware protection system application 88 initiates a responsive action. In some embodiments, initiating the responsive action comprises performing actions such as (a) instructing storage controller 26 to halt all write operations to storage devices 38, (b) generating an alert to a systems administrator to remove malware 62 from any infected computers 24, and/or (c) generating an alert to the systems administrator to check the integrity of the data stored on storage devices 38, and to restore data to the storage from a backup copy if necessary.

As described supra, malware protection system 22 can protect computers 24 from experiencing any permanent data loss due to malware 62. For example, if files 42 comprise database files, archive log files and redo log files, restoring the data (in option “c” described hereinabove) may comprise recovering a good image of the database files from a backup, and applying the protected archive and redo logs to reconstruct the last executed transaction.

In a second decision step 152, if storage controller 26 is permitted to accept any further data storage commands, then the method continues with step 142. The method ends if storage controller 26 is not permitted to accept any further data storage commands (e.g., due to the prevented action initiated in step 150).

Returning to step 148, if rule application module 130 determines that the one or more applied rules indicate that malware 62 is not executing on the given computer, then in a storing step 154, operating system layer 56 stores the data received in the storage requests to the given storage entity, and the method continues with step 142.

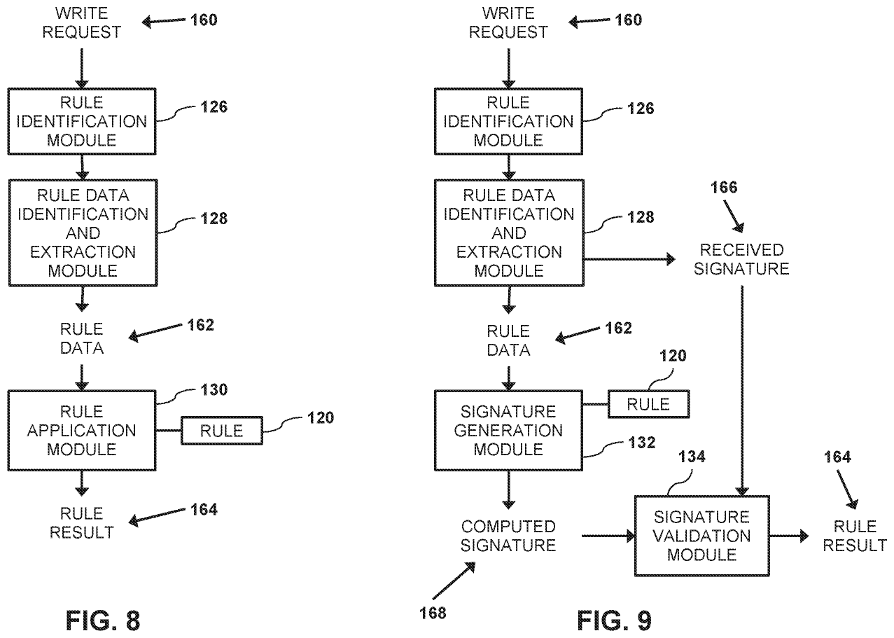

FIG. 8 is a block diagram that schematically illustrates a dataflow for detecting malware in a given computer, in accordance with the first collaboration embodiment of the present invention.

In the data flow showed in FIG. 8, operating system layer 56 receives a data write request 160 and conveys the data write request to malware protection system application 88. In malware protection system application 88, using embodiments described supra, rule identification model 126 identifies a given rule 120 for validating data write request, and rule data identification and extraction module 128 identifies and extracts rule data 162 that comprises information necessary to process the identified malware detection rule. Rule application module 130 applies the identified malware detection rule to data write request 160 so as to generate a rule result 164.

FIG. 9 is a block diagram that schematically illustrates a dataflow for detecting malware in a given computer, in accordance with a second collaboration embodiment of the present invention.

In the data flow showed in FIG. 9, operating system layer receives a data write request 160 to malware protection system application 88. In malware protection system application 88, using embodiments described supra, rule identification model 126 identifies a given rule 120 for validating data write request, and rule data identification and extraction module 128 identifies and extracts rule data 162 that comprises information necessary to process the identified malware detection rule.

In the second collaboration embodiment, data write request 160 comprises a received signature 166 that module 128 forwards to signature validation module 136, and the identified malware detection rule comprises a signature check, as described supra in the second collaboration embodiment. Signature generation module 132 computes a signature 168 based on the extracted rule data 162, and forwards the computed signature to signature validation module 136. Signature validation module 136 compares received signature 166 to computed signature 168 so as to generate rule result 164.

### APPENDIX 1—PROTECTING DATABASE ARCHIVE LOGS

In addition to redo logs for database recovery, files 42 may also comprise archive logs, which are very similar in structure to redo logs. The only difference is that while redo data is written cyclically to the same files 42, archive data is written to an archive file, and when the archive file is complete, a new archive file is allocated. Therefore, archive files are never overwritten. Once in a while, subsequent to files 42 being backed up, the archive files can be deleted, and the free space can then be used for allocating new archive files.

A valid write to a given archive file comprises the following characteristics that malware protection system 22 can use to verify that the write request was not altered by malware 62:
1. A write request to the next location in an existing archive file comprising a valid header.
2. A write request to the first location of a new archive file comprising a valid header.
3. A write request to a location outside of any archive file.

If a write request comprising a valid header is received, and not directed toward any existing archive file as represented by existing file maps, there is a possibility that a new archive file may need to be created. In this, case malware protection system application 88 can query the database for the most recent archive file map and check item 2 described supra.

In some embodiments, malware protection system application 88 may implement the following pseudocode:

If the block has a standard redo log header then
{

If block address belongs to one of the file maps and
block address is the next location to be written then
/*this is a valid write to already existing archive file

Return (OK) /*This is a good log write

Else

If block address belongs to one of the file maps and
block address is not next location to be written then
/*this is not a valid write to already existing archive
file

Return (error)

```
  Else /*Archive block does not belong to any archive file
  /*check whether write to new archive file
{
```

Get most recent file maps of archive logs
If block address in the new archive file then

If block address is first block in file then

Return (OK) /*first write to a new file

Else /*not a legal write

Return (error) /*illegal write

```
  Else /*write outside the scope of any archive file
  hence legal
```

Return (OK) /*legal write

}

}

| | |
|---|---|
| Else | /*this is not an archive log record, |

/*therefore can't be directed to any of the log files

If block address belongs to one of the file maps then

Return (error) /*illegal write

Else

```
  Return (OK) /*this is a write will not corrupt archive
  files
```

Once a backup of a good database image is taken, space of the backed up archive logs can be release by deleting the following:
All the files containing these logs.
All file maps files and their in-memory image corresponding to the deleted files.

Note: A corrupted database image can never be backed up as during the backup process the backup program checks the validity of each backed up block. If a corrupted block is detected the backup terminates. In such a case database recovery can be performed from a previous completed good backup.

### APPENDIX 2: PROTECTING MALWARE PROTECTION SYSTEM DATA

In embodiments where a DBMS application like Oracle™ may store database redo files on SAN storage devices 38A, malware protection system 22 can use the first collaboration embodiment to protect the files storing the database redo and archive logs, and the malware protection system can collaborate with file system 70 to use the second collaboration embodiment (e.g., a signature, as described supra) to protect file maps 90. In these embodiments, operating system layer 56 may comprise a first given file system 70 that the DBMS application uses to manage database files, and a second given file system 70 that malware protection system 22 uses to manage file maps 90. The second given file system may comprise a simple file system comprising the following API calls:
file_write(file_name, file_map) write the file map from buffer file_map structure for a redo file or an archive file named file_name.
file_read(file_name, file_map) reads the file map from a buffer file_map structure for a redo file or an archive file named file_name.
file_delete(file_name, file_map) reads the file map from a buffer file_map structure for a redo file or an archive file named file_name.
   In operation, the simple file system may be configured to implement the second protection embodiment described supra in order to append a custom signature (i.e., understood only by the malware protection system) to the data of every write operation.

In some embodiments, the file map maintenance application can execute the following logic:
Obtaining from the database application the file maps of the redo logs and archive logs. This can be obtained through a standard Oracle interface by querying X$KFFXP—an Extent mapping table for Oracle ASM file system.
Providing these file maps to the malware protection system to enable it to execute the redo/archive file write validation.
Maintaining the file maps on the file maps volume by writing them to the volume via the simple file system. The simple file system adds a special signature to each written block using the second protection embodiment described supra. It can also provide, to the malware protection system, the volume name and the encryption key that can be used to check the validity of this signature.

Similar technology can be used to store other types of malware protection system data 86.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
storing, by a processor in a memory, a set of malware detection rules for a set of respective storage entities, each given rule indicating, when applied to a request to write to a given respective storage entity, whether the request originates from one or more malware applications that corrupt the storage entities;
receiving, by the processor, a new request to write data to a given storage entity;
identifying, from the set of malware detection rules, a given malware detection rule corresponding to the given storage entity;
applying, by the processor, the identified malware detection rule to the received new request so as to detect that the computer is infected with a given malware application; and
initiating a responsive action upon detecting the given malware application infection.

2. The method according to claim 1, and comprising storing the data to the storage entity upon detecting, by applying the identified malware detection rule, that the computer is not infected with any given malware application.

3. The method according to claim 1, wherein at least one of the malware applications comprises a ransomware application.

4. The method according to claim 1, wherein each given storage entity is selected from a list consisting of a storage device, a logical volume, a file, a volume block and a file block.

5. The method according to claim 1, wherein the processor comprises a first processor, wherein receiving the new request comprises receiving, by the first processor, a new request from a software application executing on a second processor, and wherein a given malware detection rule is based on known behavior of how the software application stores data to the given software entity.

6. The method according to claim 1, wherein the given malware detection rule comprises an address of a first buffer, wherein the request comprises an address of a second buffer, and wherein applying the given malware detection rule comprises comparing the address of the first buffer to the address of the second buffer.

7. The method according to claim 1, wherein the given malware detection rule comprises a timeframe, and wherein applying the given malware detection rule comprises determining a time when the processor received the request, and comparing the determined time to the timeframe.

8. The method according to claim 1, wherein the given malware detection rule comprises a specified format, and wherein applying the given malware detection rule comprises comparing the received data to the specified format.

9. The method according to claim 1, wherein the given malware detection rule comprises a first location in an ordered set of the storage entities, wherein the request comprises a second location in the given storage entity, and wherein applying the given malware detection rule comprises comparing first location in the ordered set of the storage entities to the second location in the given storage entity.

10. The method according to claim 1, wherein the given malware detection rule comprises a first signature, and wherein applying the given malware detection rule comprises computing a second signature based on the new request, and comparing the first signature to the second signature.

11. The method according to claim 1, wherein the responsive action comprises generating an alert.

12. The method according to claim 1, wherein the responsive action comprises halting write operations to the storage entities.

13. An apparatus, comprising
a memory; and
a processor configured:
to store, in the memory, a set of malware detection rules for a set of respective storage entities, each given rule indicating, when applied to a request to write to a given respective storage entity, whether the request originates from one or more malware applications that corrupts the storage entities,
to receive a new request to write data to a given storage entity,
to identify, from the set of malware detection rules, a given malware detection rule corresponding to the given storage entity,
to apply the identified malware detection rule to the received new request so as to detect that the computer is infected with a given malware application, and
to initiate a responsive action upon detecting the given malware application infection.

14. The apparatus according to claim 13, wherein the processor is further configured to store the data to the storage entity upon detecting, by applying the identified malware detection rule, that the computer is not infected with any given malware application.

15. The apparatus according to claim 13, wherein at least one of the malware applications comprises a ransomware application.

16. The apparatus according to claim 13, wherein each given storage entity is selected from a list consisting of a storage device, a logical volume, a file, a volume block and a file block.

17. The apparatus according to claim 13, wherein the processor comprises a first processor, wherein the processor is configured to receive the new request comprises receiving, by the first processor, a new request from a software application executing on a second processor, and wherein a given malware detection rule is based on known behavior of how the software application stores data to the given software entity.

18. The apparatus according to claim 13, wherein the given malware detection rule comprises an address of a first buffer, wherein the request comprises an address of a second buffer, and wherein the processor is configured to apply the given malware detection rule by comparing the address of the first buffer to the address of the second buffer.

19. The apparatus according to claim 13, wherein the given malware detection rule comprises a timeframe, and wherein the processor is configured to apply the given malware detection rule by determining a time when the processor received the request, and comparing the determined time to the timeframe.

20. The apparatus according to claim 13, wherein the given malware detection rule comprises a specified format, and wherein the processor is configured to apply the given malware detection rule by comparing the received data to the specified format.

21. The apparatus according to claim 13, wherein the given malware detection rule comprises a first location in an ordered set of the storage entities, wherein the request comprises a second location in the given storage entity, and wherein the processor is configured to apply the given malware detection rule by comparing first location in the ordered set of the storage entities to the second location in the given storage entity.

22. The apparatus according to claim 13, wherein the given malware detection rule comprises a first signature, and wherein the processor is configured to applying the given malware detection rule by computing a second signature based on the new request, and comparing the first signature to the second signature.

23. The apparatus according to claim 13, wherein the responsive action comprises generating an alert.

24. The apparatus according to claim 13, wherein the responsive action comprises halting write operations to the storage entities.

25. A computer software product, the product comprising a non-transitory computer-readable medium, in which program instructions are stored, which instructions, when read by a computer, cause the computer:
to store, in a memory, a set of malware detection rules for a set of respective storage entities, each given rule indicating, when applied to a request to write to a given respective storage entity, whether the request originates from one or more malware applications that corrupts the storage entities;
to receive a new request to write data to a given storage entity;
to identify, from the set of malware detection rules, a given malware detection rule corresponding to the given storage entity;
to apply the identified malware detection rule to the received new request so as to detect that the computer is infected with a given malware application; and
to initiate a responsive action upon detecting the given malware application infection.
